(19) United States
(12) Patent Application Publication
(10) Pub. No.: US 2008/0066366 A1
(43) Pub. Date: Mar. 20, 2008

(54) Fish strike alert device

(76) Inventor: Robert Bryant Todd, Conway, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/522,720

(22) Filed: Sep. 18, 2006

(51) Int. Cl. A01K 97/12

(52) U.S. Cl. 43/17

(57) ABSTRACT

A detachable, reusable strike alert device for signaling a strike on a fishing line includes: (a) a generally watertight main housing including a translucent, bulbous end portion; (b) a pressure adjustment switch portion opposite the bulbous end portion, the pressure adjustment switch portion including a pressure adjusting switch; (c) at least one light emitting diode in the bulbous end portion; (d) an accessible battery compartment, at least one battery in the battery compartment being in connection with the pressure adjustment switch and the light emitting diode; (e) a set of electrical contacts in the pressure adjustment switch portion; and (f) an attachment mechanism on the bulbous end portion for suspending the strike alert device above-water from a fishing support; wherein, when a fishing line extending between the contacts is moved, the light emitting diode illuminates, which signals a fish strike.

### BACKGROUND OF THE INVENTION

1. Technical Field

The present invention relates to a fish strike alert device for signaling a fisherman that a fish has struck the fish bait or lure on the fishing line.

2. Background Information

Part of the allure of fishing is letting one's mind wander while one is waiting for a bite. A day dreaming fisherman, though, is unlikely to notice a fish nibbling on the hook. Also, some fishermen set out a series of hooks to increase their catch. Minding a series of hooks up and down a river or other body of water is even more difficult than attending to one. The fisherman watching one hook in a series cannot always see the other hooks from where he or she is. Sometimes it is hard to remember where the line is, much less whether there has been a strike at the bait or lure. The difficulty level increases many times once night falls. It is almost impossible to see a fishing line in the water at night. Even the fishing rod itself can be difficult to see at night. This makes it problematic to take advantage of the unique benefits night fishing affords.

The fish strike alert device of the present invention notifies a fisherman with visual and/or audio signals when a fish strikes the fishing line or lines in the daytime or nighttime. This leaves the fisherman free to attend to other fishing-related tasks, or just to lay back, relax, and day dream.

### BRIEF SUMMARY OF THE INVENTION

The present invention is a fish strike alert device for signaling a fisherman when a fish strikes his or her fishing bait or lure. The fish strike alert device includes: (a) a generally watertight main housing comprising a translucent, bulbous end portion; (b) a pressure adjustment switch portion opposite the bulbous end portion, the pressure adjustment switch portion comprising a pressure adjusting switch; (c) at least one light emitting diode in the bulbous end portion; (d) an accessible battery compartment within the housing for holding batteries, at least one battery in the battery compartment being in connection with the pressure adjustment switch portion and the light emitting diode; (e) a set of electrical contacts in the pressure adjustment switch portion; and (f) an attachment mechanism on the bulbous end portion for suspending the strike alert device above-water from a support adjacent a fishing area. When a fishing line passing between the contacts is removed, the light emitting diode illuminates, which signals a strike. The detachable, reusable strike alert device preferably also includes a circuit board in the bulbous end portion for producing an audible sound, such as a chirping sound. The circuit board is also connected to the battery or batteries. An electromagnetic power source can be used in place of the battery compartment and batteries as a power source for the strike alert device.

Advantages of the fish strike alert device of the present invention include the following:
1) It frees the fisherman to attend to other tasks;
2) A single fisherman can easily mind a string of spaced apart hooks;
3) Sensitivity levels can be pre-set so that the fisherman is notified of even a slight tugging on the fishing line; alternatively, the fisherman can set a higher tension setting so as to ignore slight tugs attributable, for example, to ocean surf or live bait on the line;
4) The strike alert device is easy to transport, set in place, and remove;
5) The fisherman is notified by visual or audio signals, or both, when a fish strikes;
6) The visual and audio signals permit the strike alert device to be used day or night; and
7) The strike alert device can be repeatedly reused.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 shows a side elevational view of a fish strike alert device according to the present invention;

FIG. 2 is a perspective view of a fish strike alert device according to the present invention, shown in use suspended from a branch over a stream;

FIG. 3 is a perspective view of a fish strike alert device according to the present invention, shown in condition of use on a fishing pole;

FIG. 4 is an end elevational view of a pressure adjustment switch portion of the fish strike alert device according to FIG. 1;

FIG. 5 is a top plan view of a lower switch housing portion of the fish strike alert device according to FIG. 1, shown with a pressure adjustment screw detached;

FIG. 6 shows a side elevational view of a fish strike alert device according to the present invention, shown with side guides; and

FIG. 7 is a rear cross-sectional view of a strike alert device according to the present invention, shown with a pressure adjustment screw.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

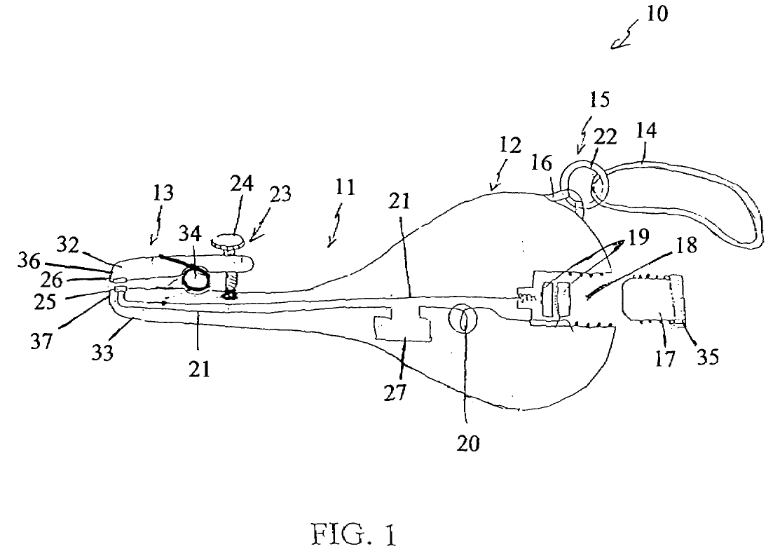

Turning first to FIG. 1, a detachable, reusable fish strike alert device, generally referred to as 10, according to the present invention includes:
(a) a generally watertight, gourd-shaped main housing 11 comprising a translucent, bulbous end portion 12;
(b) a pressure adjustment switch portion 13 opposite the bulbous end portion 12, the pressure adjustment switch portion 13 comprising a pressure adjusting switch 23
(c) at least one light emitting diode 20 in the bulbous end portion 12;
(d) an accessible battery compartment 18 for holding batteries 19, preferably in the bulbous end portion 12, the batteries being connected to the pressure adjustment switch portion 13 and the light emitting diode 20;
(e) at least two battery contacts 25, 26 in the pressure adjustment switch portion 13; and
(f) an attachment mechanism 15 on the bulbous end portion 12 for suspending the strike alert device 10 on a tree branch 28, fishing pole, or other support over/above a fishing area. When a fishing line 30 passing between the contacts 25, 26 is moved, the light emitting diode 20 illuminates, which signals a strike.

The portable fish strike alert device 10 preferably further includes a circuit board 27 or other mechanism in the bulbous end portion 12 for producing an audible sound, such as a chirping or beeping sound or a musical tune. The audible sound enhances use of the strike alert device during daylight hours. The electrical wiring 21 also extends between the audio circuit board 27 and the battery 19, and the circuit board and a lower one of the contacts 25. When the fishing line 30 passing between the contacts 25, 26 is removed, the resulting audible sound signals a strike on the line 30. Other suitable sound alerting mechanisms may also be employed herein.

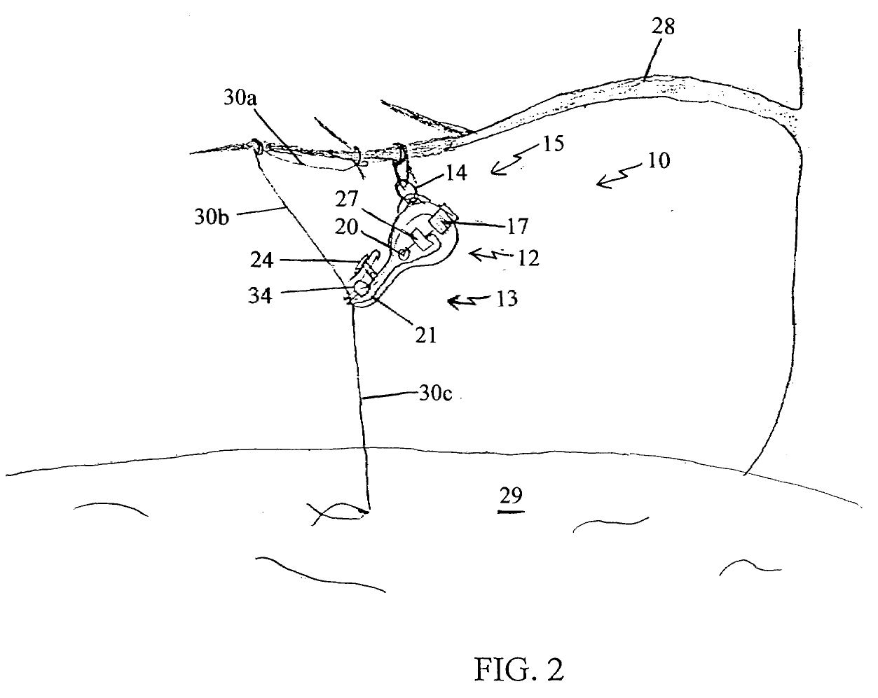

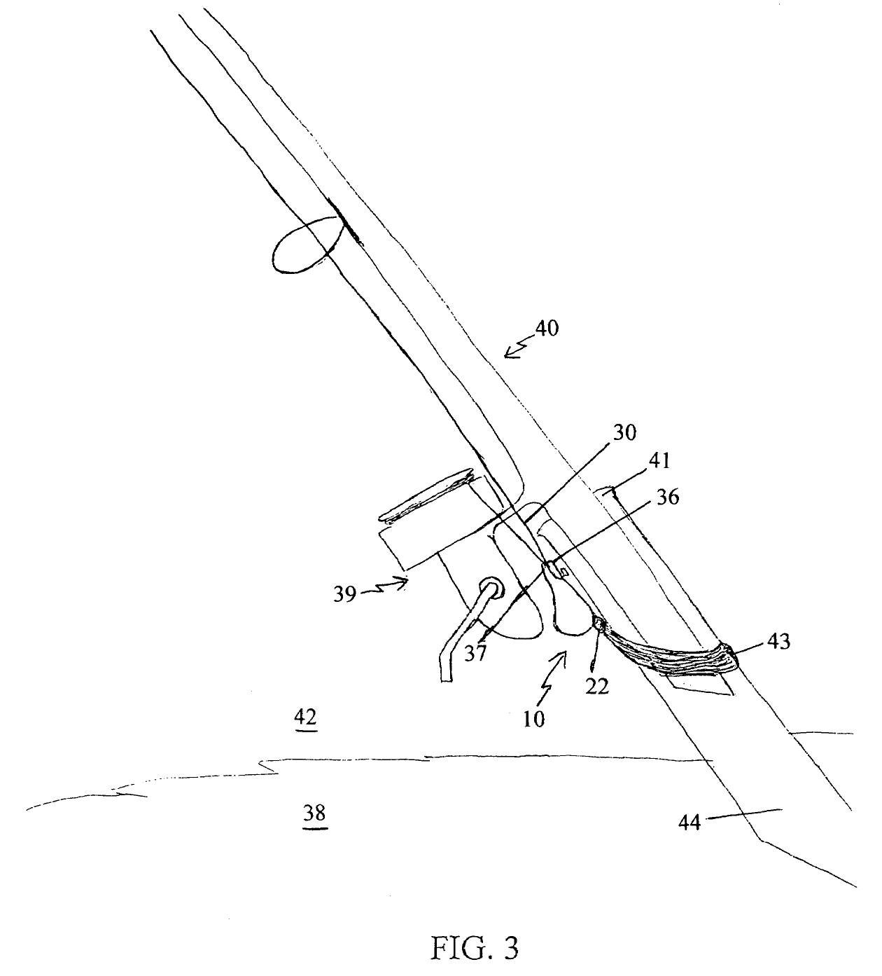

Although the strike alert device 10 can be used anytime, it is particularly useful for fishing at dusk, night, or just in dim light. Light from the light emitting diode 20 is visible from a substantial distance. The device 10 is removably attachable to a support, such as a fishing pole 40 as shown in FIG. 3, or, preferably a branch 28 (e.g., a limb) overhanging a fishing spot, as shown in FIG. 2. An individual strike alert device 10 is attachable to any object/mechanism useful for fishing that utilizes a fishing line.

As illustrated in FIGS. 1 and 2, the attachment mechanism 15 for suspending the strike alert device 10 includes a loop 14 attached to an O-ring 22. The preferred strike alert device 10 shown in FIG. 2 is removably hung from the flexible loop 14 over a branch 28 overhanging a stream 29 or another body of water suitable for fishing. The attachment mechanism 15 may alternatively include braided rope, and/or strips of hook and loop material. In FIG. 2, the keychain-type O-ring 22 is attached to a hook 16 on the main housing 11.

The fish strike alert device 10 can be suspended from the butt or reel end of a fishing pole mounted at an angle in the sand (e.g., on a sand spike) or other type of ground adjacent to the beach or other body of water in which the fisherman is fishing. The term “fishing pole” as used herein is meant to include fishing rods. The strike alert device 10 can be hung from or positioned in any suitable support, such as a limb, pole, or sand spike, via any suitable attachment mechanism, next to or over the stream or other body of water where the fisherman is fishing.

As shown in FIG. 3, the handle end of a conventional fishing pole 40 is inserted in a receiving end 41 of a sand spike 44. The opposite, lower end of the sand spike 44 has been inserted into the sand 38 at a beach adjacent the ocean 42. A portion of the fishing line 30 from the reel 39 extends between the contacts 25, 26 in the pressure adjustment switch portion 13 of the strike alert device 10. An O-ring 22 is attached to the main housing 11 at the opposite, bulbous end portion 12 of the strike alert device 10. Complementary strips of hook and loop 43 extending through the O-ring 22 encircle the sand spike 44 and help to support the strike alert device 10 against the sand spike 44. The strike alert device can easily be removed from the fishing pole and re-used later. The opposite, baited end (not shown in FIG. 3) of the fishing line 30 extends out into the ocean 42. The detachable device 10 preferably dangles adjacent the fishing reel of the pole.

As seen in FIGS. 2 and 3, a length of fishing line 30 passes between the contacts 25, 26 of the fish strike alert device 10. As shown in FIG. 2, an end of the fishing line 30 dangles in the stream 29 or other body of water from the branch 28. Preferably, a fishing hook 31 with bait or a lure is attached to the end of the fishing line 30 that is dangling in the water.

The strike alert device 10 can also be suspended from a cleat or the like on a fishing boat or dock, a handrail, a rail post, or a dock post on a boat dock (not shown). Several strike alert devices 10 can be suspended from several different cleats on a watercraft to notify a fisherman of any fish strikes. Meanwhile, the fisherman can turn his or her attention to other activities. The word “strike” as used herein is meant to include striking, nibbling, and/or hooking a line.

The battery compartment 18 is preferably accessible via a threaded stopper 17 that fits closely into an open upper end of the compartment 18 so the batteries can be changed. The stopper 17 can be removed in order to replace the batteries 19, which are preferably dime sized. The stopper 17 has a stopper O-ring 35 at its upper end. Alternatively, the battery compartment 18 may be closable by a watertight compartment door (not shown). The strike alert device 10 is not subject to corrosion.

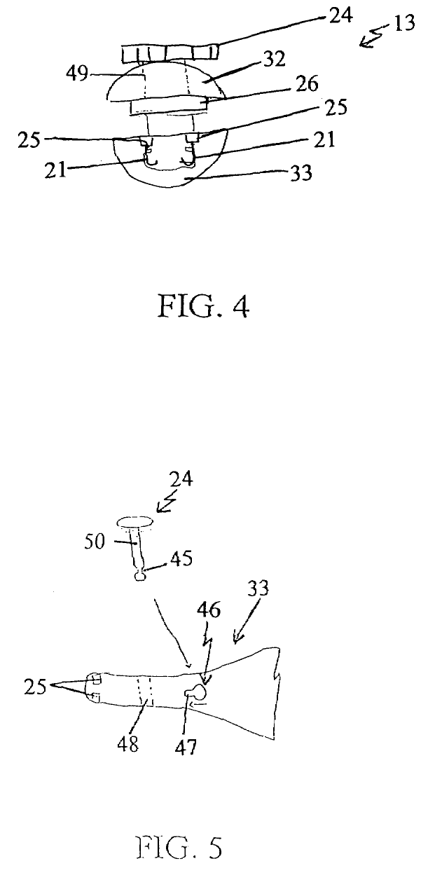

As shown in FIGS. 1 and 4, the pressure adjustment switch portion 13 includes a separate upper switch housing portion 32 (which is preferably made of plastic) adjacent a lower switch housing portion 33 of the main housing 11. An upper electrical contact 26 is attached to the upper switch housing portion 32, and two spaced-apart lower contacts 25 are attached side by side to the lower switch housing portion 33 near the bottom end of the strike alert device 10. The front ends of the upper switch housing portion 32 and the lower switch housing portion 33 form “jaws” 36, 37. As seen in FIG. 1, the upper switch housing portion 32 and lower switch housing portion 33 are substantially separated from one another by a narrow space. This is the storage adjustment position achieved by reducing pressure using the pressure adjustment screw 24. The pressure adjusting switch 23 essentially controls the amount of holding pressure between the jaws 36, 37.

In the preferred embodiment shown in FIGS. 1-3, wiring 21 extends from a first one of the lower contacts 25 up within the interior of the strike alert device 10 to the battery compartment 18, where it can be energized by the battery or batteries 19 in the battery compartment. The electrical wiring 21 also extends from the other (second) lower contact 25 to the light emitting diode 20, which is preferably located at the approximate center of the bulbous portion 12, and from the light emitting diode 20 to the battery or batteries 19. If desired, an additional contact can be employed in the device, with a wire 21 in the upper switch housing portion 32 extending from the upper contact 26 down to the battery or batteries 19.

The circuit board 27 or other sound producing unit can be in front of or behind the light emitting diode 20, in series or in parallel. In an embodiment of the present device having both light and sound, the light emitting diode 20 is illuminated and the audible alarm is sounded when the fishing line 30 passing between the contacts 25, 26 is removed with sufficient force. The light and sound signal a strike.

The translucent bulbous portion 12 is made of any suitable material that permits light from the light emitting diode 20 to shine through (e.g., polycarbonate material). The word “translucent” herein is meant to include transparent or opaque. The coiled portion of a spring 34 between the switch housing portions 32, 33 maintains alignment between the electrical contacts 25, 26 and spring pressure on the mechanism.

Continuing with FIG. 4, the switch 23 is normally closed. The upper contact 26 contacts the bottom contacts 25 when the fishing line 30 is not present. The term “fishing line” as used herein is meant to include monofilament line, string, or any flexible line suitable for use in fishing. The pressure adjustment mechanism permits adjustment for various diameters of line. When a fish strikes, the fish pulls the length of fishing line 30 from the switch. When this occurs, the electrical circuit is activated and positive voltage passing across the contacts 25, 26 causes the light emitting diode 20 to illuminate and sound to be emitted from the strike alert device 10. This provides the fisherman with a visual and/or audio signal of a fish strike. Light is emitted from all around the bulb-shaped bulbous end portion, not just from one end of the strike alert device 10. When the fishing line 30 extends between the contacts 25, 26, the electrical circuit is interrupted, so the light emitting diode 20 is not illuminated and the sound is not emitted. The light emitting diode 20 is not illuminated unless the fishing line 30 is moved a sufficient amount. It should be noted that other marine or freshwater vertebrates besides bony fish can pull the fishing line, such as crabs, lobsters, or eels, which will have the same effect. Thus, the strike alert device may be used to “fish” for other marine life in addition to bony fish.

Continuing with FIG. 1, the pressure adjustable screw 24 in the pressure adjustment switch portion 13 of the strike alert device 10 extends through a threaded hole in the upper switch housing 32 perpendicular to the longitudinal axis of the strike alert device. The end of the pressure adjustment screw 24 contacts the lower switch housing portion 33. A user can adjust tension by rotating the head of the pressure adjustment screw 24.

Tightening the pressure adjustment screw 24 increases pressure at the adjustment switch (or clip), so that more of a jerk on the fishing line is required for the light emitting diode 20 to be illuminated (versus before the screw was tightened). (Tightening the pressure adjustment screw 24 raises the upper switch housing portion 32, which pushes the upper jaw 36 down.)

Conversely, loosening the pressure adjustment screw 24 increases sensitivity, so that less tension is required for the switch to be closed, or the fishing line to be pulled out of the switch, thus illuminating the light emitting diode 20. (Loosening the pressure adjustment screw 24 lowers the upper switch housing portion 32, which permits the upper jaw 36 to move up, which reduces pressure on the line.) The pressure adjusting switch 23 can be adjusted to prevent live bait, ocean surf, a current, or the like from inadvertently pulling the fishing line from the switch. This would result in a false reading of a strike. The pressure adjustment screw 24 is adjustable according to the size of the live bait on the end of the fishing line. The pressure adjustment screw 24 can be used to increase the pre-determined tension where, for example, bigger bait is to be used on the fishing line.

As shown in FIG. 5, the shaft 50 of the pressure adjustment screw 24 preferably includes an indentation 45 encircling the lower end of the screw shaft 50, which is the end opposite the head of the screw. For the purpose of illustration, the pressure adjustment screw 24 is shown detached in FIG. 5. The indented end of the pressure adjustment screw shaft 50 is insertable into a generally teardrop-shaped pressure adjustment screw pocket 46 in the upper side of the lower switch housing portion 33 (see FIGS. 5 and 7) once the pressure adjustment screw shaft 50 has been inserted through the threaded hole 49 in the upper switch housing portion 32 (see FIGS. 1 and 4). In use, rotating the pressure adjustment screw 24 clockwise or counterclockwise moves the upper switch housing portion 32 up or down. The pressure adjustment screw pocket 46 comprises a narrowed slot 47. The narrower slot 47 has a width between the smaller diameter of the indented shaft portion 45 of the pressure adjustment screw and the larger diameter of the remainder of the screw shaft 50. The lower end of the screw shaft 50 is inserted into the screw pocket 46 and the screw 24 is pushed forward so that the shaft indentation 45 is lodged in the narrower forward slot 47. The narrowed forward slot 47 of the pressure adjustment screw pocket 46 inhibits withdrawal of the pressure adjustment screw 24 from the lower switch housing portion 33 of the fish strike alert device 10 (see FIG. 5), even if the device 10 is turned upside down.

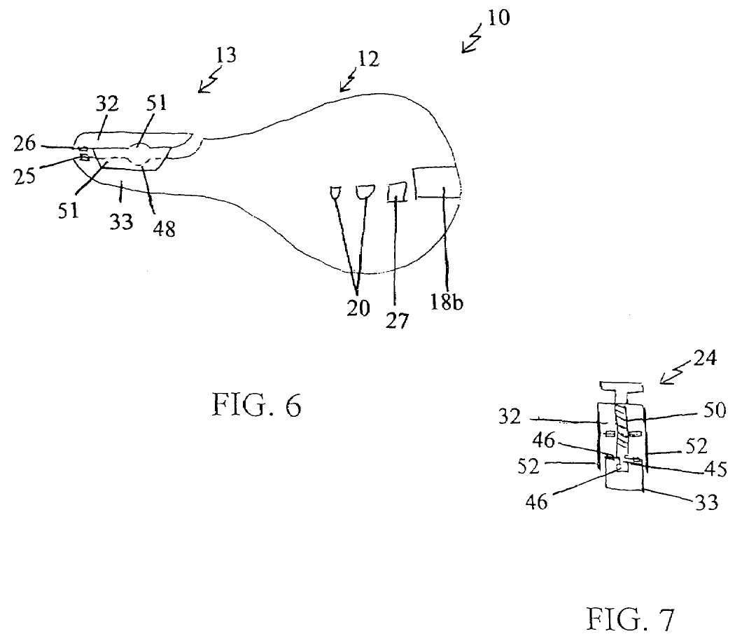

Between the pressure adjustment screw pocket 46 and the lower contacts 25 at the end of the lower switch housing portion 33 is a shallow lower groove 48 that accommodates the spring 34. The lower spring groove 48 is indicated by dashed lines in FIG. 5. The strike alert device 10 preferably also includes an upper spring groove 51 in the upper switch housing portion opposite the lower spring groove 48, as seen in FIG. 6. The coiled portion of the spring 34 preferably rests in the two spring grooves 48, 51. The spring 34 and spring grooves 48, 51 help to prevent the switch housing portions 32, 33 from slipping out of alignment with one another. The spring 34 also provides a pivot point for the upper switch housing portion 32, and maintains the upper switch housing portion 32 over the lower switch housing portion 33.

In the embodiment shown in FIGS. 6 and 7, the strike alert device includes matching guides 52 extending down in a generally vertical direction from either side of the upper switch housing portion 32. The two side guides 52 help to prevent the switch housing portions 32, 33 from slipping out of alignment. The side guides 52 also serve to prevent debris from entering the space between the upper and lower switch housing portions 32, 33. When the upper switch housing portion 32 is in place over the lower switch housing portion 33, the ends of the guides 52 slightly overhang the lower switch housing portion 33, as seen in FIG. 7. They are therefore effective regardless of what position the upper switch housing portion 32 is in. The side guides 52 can be present on any of the embodiments described herein.

In use, the bulbous end portion 12 is attached to the branch 28 or other support via the attachment mechanism 15 on the bulbous end portion, as seen in FIG. 2. An upper end section 30a of the length of flexible fishing line 30 is tied onto the branch 28 or other support adjacent the attachment mechanism 15, so that a middle section 30b of the fishing line is in a position to slant down at an angle toward the upper and lower jaws 36, 37. The middle section 30b of line most preferably forms about a 60 degree angle with respect to the device. The fishing line 30 passes through the device jaws 36, 37 between the contacts 25, 26. A lower end section 30c of the line drops by gravity into the water 29.

When the strike alert device 10 is affixed to a fishing pole 40 in a sand spike 44 as shown in FIG. 3, the device 10 is positioned alongside the sand spike 44, with the bulbous end portion 12 lower than the jaws 36, 37. The strips of hook and loop 43, which extend through the O-ring 22 on the bulbous end portion 12, encircle the sand spike 44. A length of line 30 from the fishing reel 39 extends down between the jaws 36, 37 of the strike alert device 10 as seen in FIG. 3. From there, the line 30 extends up along the fishing pole 40 in a conventional manner.

The portable, reusable strike alert device 10 is positioned above-water, such as on an overhanging branch of a tree (including a bush) without a fishing pole. The device 10 may be positioned adjacent a fishing pole in a sandy beach or on a dock. Even though the lightweight strike alert device 10 is not intended for use in the water, the device 10 bobs like a cork if it falls into the water. The bulbous end portion 12 of the strike alert device 10 is hollow and air-tight, which conveys this advantage. The floating bulbous end portion 12 is visible above the waterline, so that the fisherman can see it from a distance and retrieve it. The non-translucent portion of the strike alert device 10 is preferably fluorescent-colored for better visibility. The entire strike alert device 10 may be watertight and floatable.

It is to be understood that the main housing 11 and light emitting diode 20 can be various colors, such as clear orange, red, blue, or yellow. Having multiple strike light devices 10 in different colors facilitates their use on a fishing expedition. Using multiple strike light devices 10 on branches, etc. overhanging favorite fishing spots makes fishing more relaxing, since it eliminates the need to continually check all of the hooks the fisherman has in the water. For example, a fisherman who is night fishing for crappie sees a yellow light illuminate over the river and knows which fishing pole to grab. The present strike alert device is not intended to be a fishing lamp, since the light only illuminates when the line is pulled. The fisherman can leave that area once the strike light device is set. The fisherman returns once he or she is signaled by the strike light device.

A strike alert device 10 may include more than one light emitting diode 20. For example, in FIG. 6, a strike alert device 10 includes two light emitting diodes 20, which both illuminate when the line is moved. In some strike alert devices 10, the light emitting diodes 20 may flash or blink once they are set off by a jerk on the line. The strike alert device 10 can further include a microprocessor, though the strike alert device works well without one.

An alternate embodiment matching the strike alert device 10 as shown in FIG. 6 and described hereinabove includes: (a) a generally watertight main housing 11 comprising a translucent, bulbous end portion 12; (b) a pressure adjustment switch portion 13 opposite the bulbous end portion 12, the pressure adjustment switch portion 13 comprising a pressure adjusting switch 23; (c) at least one light emitting diode 20 in the bulbous end portion 12; (d) an electromagnetic power source 18b in the bulbous end portion 12, the electromagnetic power source powering the pressure adjusting switch 23 and the light emitting diode 20; (e) at least two contacts 25, 26 or the like in the pressure adjustment switch portion 13 for sensing movement of the fishing line 30; and (f) an attachment mechanism 15 on the bulbous end portion 12 for suspending the strike alert device 10 on a fishing support adjacent a fishing area. When a fishing line 30 passing between the contacts 25, 26 is moved, the light emitting diode 20 illuminates, which signals a strike on the line. The strike alert device 10 preferably also includes an audible alarm mechanism, such as a circuit board, as described above. This embodiment optionally includes side guides 52 as described above. A battery compartment 18 may be utilized in place of the electromagnetic power source 18b.

From the foregoing it can be realized that the described device of the present invention may be easily and conveniently utilized as a fish strike alert device. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 fish strike alert device
11 main housing
12 bulbous end portion
13 pressure adjustment switch portion
14 loop
15 attachment mechanism
16 attachment hook
17 compartment stopper
18 battery compartment
19 battery
20 light emitting diode
21 electrical wiring
22 O-ring
23 pressure adjusting switch
24 pressure adjustment screw
25 lower battery contact
26 upper battery contact
27 circuit board
28 tree branch
29 stream
30 fishing line
31 fishing hook
32 upper switch housing portion
33 lower switch housing portion
34 spring
35 stopper O-ring
36 upper jaw
37 lower jaw
38 sand on a beach
39 fishing reel
40 fishing pole
41 receiving end of sand spike
42 ocean
43 hook and loop material
44 sand spike
45 pressure adjustment screw indentation
46 pressure adjustment screw pocket
47 narrowed slot
48 lower spring groove
49 upper switch housing portion hole
50 pressure adjustment screw shaft
51 upper spring groove
52 guides

What is claimed is:

1. A fish strike alert device, comprising:
(a) a generally watertight main housing comprising a translucent, bulbous end portion;
(b) a pressure adjustment switch portion opposite the bulbous end portion, the pressure adjustment switch portion comprising a pressure adjusting switch;
(c) at least one light emitting diode in the bulbous end portion;
(d) an accessible battery compartment within the main housing, at least one battery in the battery compartment being in electrical connection with the pressure adjustment switch portion and the light emitting diode;
(e) a set of electrical contacts in the pressure adjustment switch portion; and
(f) an attachment mechanism on the bulbous end portion for suspending the strike alert device above-water from a fishing support.

2. The strike alert device according to claim 1, wherein, when a fishing line extending between the contacts is moved, the at least one light emitting diode in the device is illuminated, which signals a strike on the line.

3. The strike alert device according to claim 1, further comprising an audible signal circuit board in the bulbous end portion for producing an audible sound.

4. The strike alert device according to claim 1, further comprising electrical wiring connecting a first lower one of the contacts to the at least one battery, and a second lower one of the contacts to the light emitting diode within the bulbous portion, and connecting the light emitting diode to the at least one battery.

5. The strike alert device according to claim 1, wherein the pressure adjustment switch portion comprises a separate upper switch housing portion adjacent a lower switch housing portion of the main housing.

6. The strike alert device according to claim 5, comprising more than one of the light emitting diodes.

7. The strike alert device according to claim 5, wherein the device is not connected to a fishing pole and is attachable to a branch of a tree.

8. The strike alert device according to claim 5, wherein electrical wiring connects an upper one of the contacts in the upper switch housing portion to the at least one battery.

9. The strike alert device according to claim 5, further comprising a spring between the lower and upper switch housing portions.

10. The strike alert device according to claim 9, wherein the lower switch housing portion of the fish strike alert device further comprises a lower groove adjacent a lower set of two of the contacts on the lower switch housing portion, a portion of the spring being insertable in the lower spring groove.

11. The strike alert device according to claim 10, wherein the upper switch housing portion of the fish strike alert device further comprises a groove adjacent an upper one of the contacts on the upper switch housing portion, a portion of the spring being insertable in the upper spring groove.

12. The strike alert device according to claim 1, wherein the pressure adjusting switch comprises a pressure adjustment screw, a shaft of the pressure adjustment screw comprising an indentation at the end of the shaft opposite a head of the screw, the screw shaft being insertable through a threaded hole in the upper switch housing portion.

13. The strike alert device according to claim 12, wherein the indented end of the pressure adjustment screw shaft is insertable into a generally teardrop-shaped pressure adjustment screw pocket in the lower switch housing portion.

14. The strike alert device according to claim 13, wherein the pressure adjustment screw pocket comprises a narrowed slot, the narrowed slot having a width between the diameter of the indented shaft portion of the pressure adjustment screw and the diameter of the remainder of the screw shaft.

15. The strike alert device according to claim 5, wherein the attachment mechanism is strips of hook and loop material.

16. The strike alert device according to claim 5, wherein the fishing support is a fishing pole and the strike alert device detachably dangles adjacent a fishing reel of the fishing pole.

17. The strike alert device according to claim 5, wherein at least the bulbous portion of the strike alert device is hollow and air-tight, so that it floats; the bulbous end portion being opposite and continuous with the lower switch housing portion, both portions being within the generally gourd-shaped main housing.

18. The strike alert device according to claim 3, wherein the circuit board is connected to a lower one of the contacts and the at least one battery, and the audible sound is a chirping sound.

19. The strike alert device according to claim 1, further comprising a set of matching guides, wherein each of the guides extends down in a generally vertical direction from an opposite side of the upper switch housing portion.

20. A fish strike alert device, comprising:
(a) a generally watertight main housing comprising a translucent, bulbous end portion;
(b) a pressure adjustment switch portion opposite the bulbous end portion, the pressure adjustment switch portion comprising a pressure adjusting switch;
(c) at least one light emitting diode in the bulbous end portion;
(d) an electromagnetic power source in the bulbous end portion, the electromagnetic power source powering the pressure adjusting switch and the light emitting diode;
(e) a set of contacts in the pressure adjustment switch portion; and
(f) an attachment mechanism on the bulbous end portion for suspending the strike alert device over water on a fishing support; wherein, when a fishing line passing between the contacts is moved, the light emitting diode illuminates.
